(19) United States
(12) Patent Application Publication
(10) Pub. No.: US 2022/0136286 A1
(43) Pub. Date: May 5, 2022

(54) Steel Frame Door Locking Assembly

(71) Applicant: William Howell Wade, II, Las Vegas, NV (US)

(72) Inventor: William Howell Wade, II, Las Vegas, NV (US)

(21) Appl. No.: 17/508,724

(22) Filed: Oct. 22, 2021

Related U.S. Application Data
(60) Provisional application No. 63/109,100, filed on Nov. 3, 2020.

(51) Int. Cl. E05B 63/00; E05B 47/00

(52) U.S. Cl. CPC E05B 63/0052; E05B 47/0001; E06B 5/113; E05B 2047/0016; E05B 2047/0094

(57) ABSTRACT

A frame door locking assembly suited for reinforcing doors with additional security measures is presented. The frame door locking assembly comprises a mounting frame, at least one track assembly, at least one latch assembly, at least one actuator, and a processing unit. The at least one track assembly traverses along the mounting frame. The at least one latch assembly is distributed about the mounting frame. The at least one latch assembly is hingedly connected to the at least one track assembly. The at least one actuator is connected adjacent to the mounting frame. The at least one actuator is operatively engaged to the at least one track assembly, where the at least one actuator is configured to move the at least one track assembly in a locked configuration and an unlocked configuration. The processing unit is electronically connected to the at least one actuator.

### The current application claims a priority to the U.S. Provisional Patent application serial number 63/109,100 filed on November 03, 2020.

### FIELD OF THE INVENTION

The present invention relates to doors. More specifically, the present invention is a sturdy steel frame and locking mechanisms utilized to provide increased security for any existing or new construction door.

### BACKGROUND OF THE INVENTION

A door is defined as a hinged, sliding, or revolving barrier at the entrance to a building, room, or vehicle, or in the framework of a cupboard. Primarily speaking, when thinking of a door, typically a doorway within a building is thought of. Standard doors found within a building usually comprise of a locking mechanism for safety and/or privacy reasons. It is important to note that not all doors have the same lock in terms of design and strength. For example, an entry door for a house may have multiple locking mechanisms to prevent intruders from possible breaking in unexpectedly versus a bedroom door where a single lock is typically found within the doorknob of the door itself. In addition, when it comes to emergency, some doors lack strength and safety when it comes to the locking mechanism found on the doors.

An objective of the present invention is to provide increased security of locking mechanisms for any existing or new construction door. The present invention is a sturdy steel frame with attached locking mechanisms utilized to provide increased security for any existing or new construction door. The present invention is installed on existing or new construction doors. The present invention also provides the user the technology to observe the entry of a door without physically being near the vicinity of the door by means of a plurality of cameras and audio devices. In addition, the present invention allows the user to converse and interact with a person in the outer entry environment prior to entry.

### SUMMARY OF THE INVENTION

The present invention is a frame door locking assembly suited for reinforcing doors with additional security measures. The frame door locking assembly comprises a mounting frame, at least one track assembly, at least one latch assembly, at least one actuator, and a processing unit. In the preferred embodiment of the present invention, the frame door locking assembly denies entry to intruders by means of increased passive support for the existing door frame, hinges, door, and deadbolt locking mechanism. The frame door locking assembly is used to prevent a door from opening in the instance that the existing aforementioned components fail. In the preferred embodiment of the present invention, the frame door locking assembly is made in various shapes and sizes to accommodate any existing doorway system. In the preferred embodiment of the present invention, the frame door locking assembly is made out of steel, but may be made of any other suitable material, such as, but not limited to impact resistance polymers, epoxy reinforced fibers, or any other suitable material. The at least one track assembly traverses along the mounting frame. The mounting frame may take the form of a reinforced frame that installs along any existing door frame. The mounting frame not only reinforces the door frame it is installed on, but also serves as the mounting platform for the components the constitutes the frame door locking assembly. In the preferred embodiment of the present invention, the mounting frame is made out of steel, but may be made out of any other suitable material. The at least one latch assembly is distributed about the mounting frame. The at least one latch assembly is hingedly connected to the at least one track assembly.

The at least one actuator is connected adjacent to the mounting frame. The at least one actuator is operatively engaged to the at least one track assembly, where the at least one actuator is configured to move the at least one track assembly between a locked configuration and an unlocked configuration. The processing unit is electronically connected to the at least one actuator. In the preferred embodiment of the present invention, the track assembly bridges the at least one latch assembly to the actuator, such that the track assembly actuates the at least one latch assembly along the door frame. The at least one latch assembly serves as the locking agent. In the unlocked configuration, the at least one latch assembly is retracted within the mounting frame. In the locked configuration, the at least one latch assembly deploys out of the mounting frame, such that the at least one latch assembly secures along the door, securing the door to the mounting frame. In the preferred embodiment of the present invention, the at least one track assembly is made out of steel, but may be made out of any other suitable material. In the preferred embodiment of the present invention, the at least one latch assembly is made out of steel, but may be made out any other suitable material. In the preferred embodiment of the present invention, the mounting frame is installed along the interior side of the door frame, such that the at least one track assembly and the at least one latch assembly is oriented along the interior side of the door. In this orientation, the frame door locking assembly is designed to prevent intruders from kicking or breaking down the door from the outside.

### BRIEF DESCRIPTION OF THE DRAWINGS

FIG. 1 is an illustration of the present invention that shows the present invention in a locked configuration.

FIG. 2 is an illustration of the present invention that shows the present invention in a unlocked configuration.

FIG. 3 is an illustration of the present invention that shows the interaction between an at least track assembly to the mounting frame.

FIG. 4 is an illustration of the present invention that shows the interaction between the action arm and an actuator.

FIG. 5 is an illustration of the present invention that shows a latching assembly in the unlocked configuration.

FIG. 6 is an illustration of the present invention that shows a latching assembly in a locked configuration.

FIG. 7 is an illustration of the present invention that shows a releasing element.

FIG. 8 is a circuit diagram of the electronic components that constitutes the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

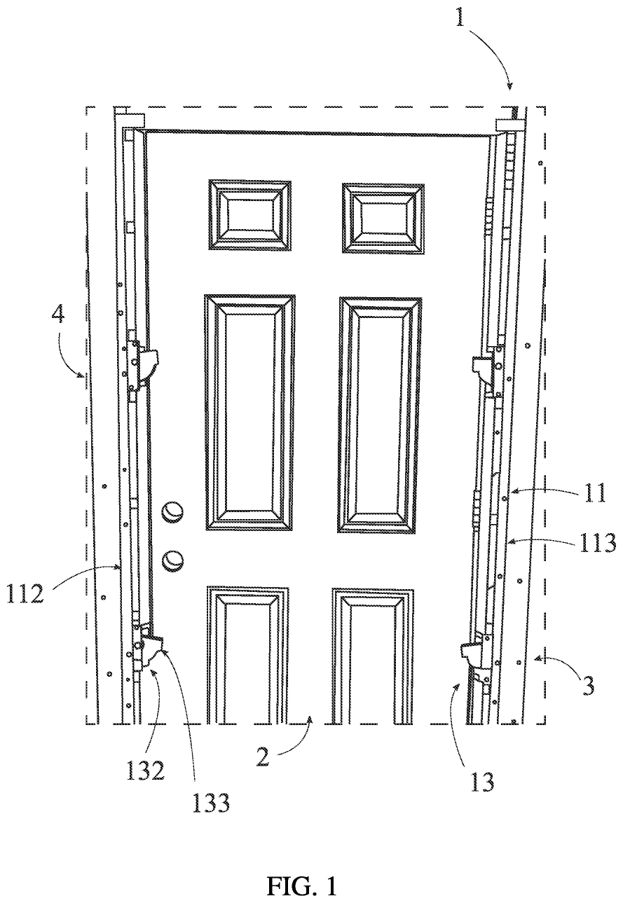

The present invention is a frame door locking assembly 1 suited for reinforcing doors 2 with additional security measures, as shown in FIGS. 1-3 and 7. In reference to FIGS. 1-8, the frame door locking assembly 1 comprises a mounting frame 11, at least one track assembly 12, at least one latch assembly 13, at least one actuator 14, and a processing unit 15. In the preferred embodiment of the present invention, the frame door locking assembly 1 denies entry to intruders by means of increased passive support for the existing door frame 3, hinges, door 2, and deadbolt locking mechanism. The frame door locking assembly 1 is used to prevent a door 2 from opening in the instance that the existing aforementioned components fail. In the preferred embodiment of the present invention, the frame door locking assembly 1 is made in various shapes and sizes to accommodate any existing doorway system. In the preferred embodiment of the present invention, the frame door locking assembly 1 is made out of steel, but may be made of any other suitable material, such as, but not limited to impact resistant polymers, epoxy reinforced fibers, or any other suitable material.

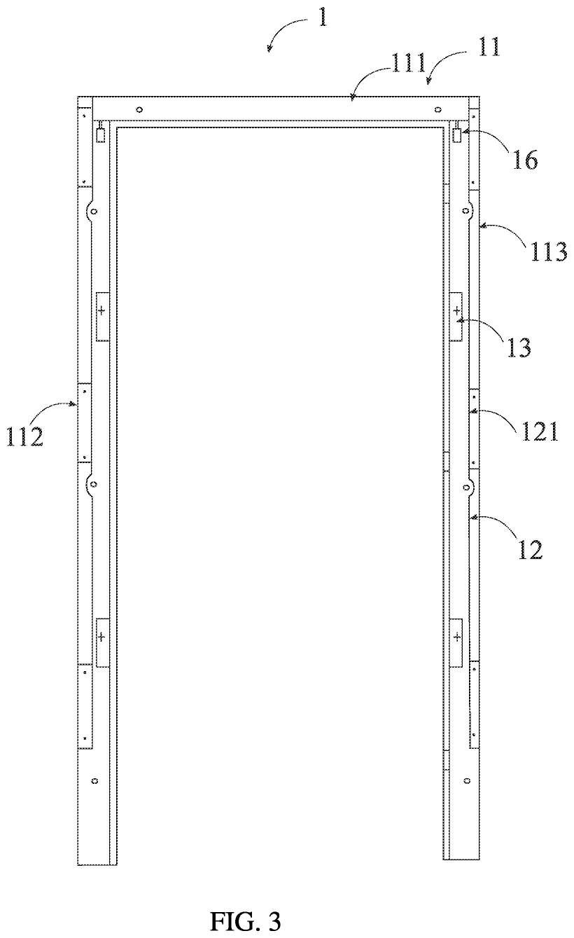

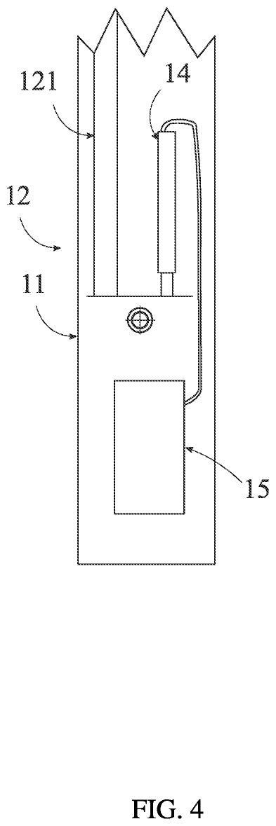

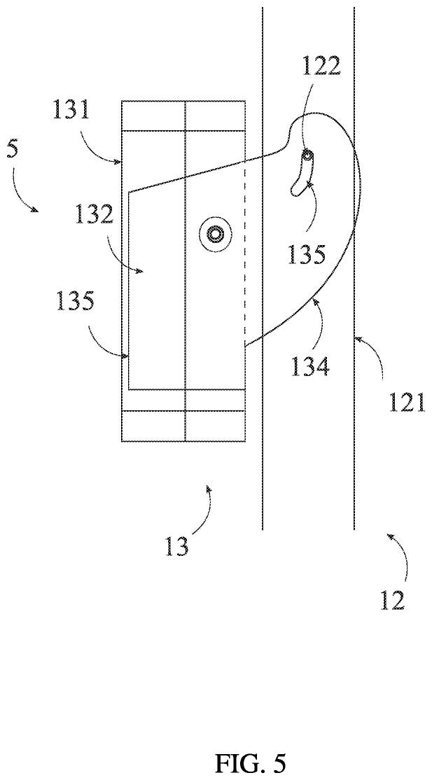

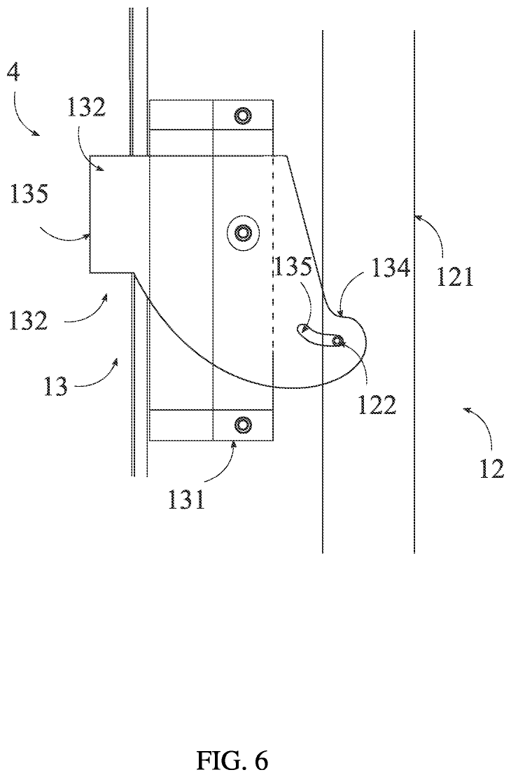

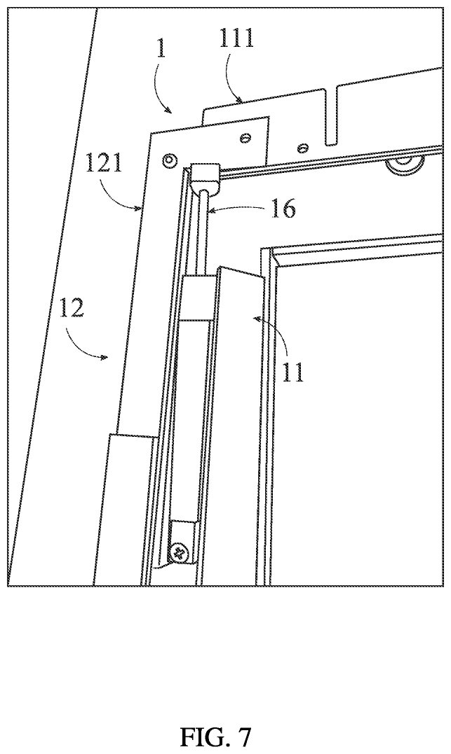

The at least one track assembly 12 traverses along the mounting frame 11, as shown in FIGS. 3 and 7. The mounting frame 11 may take the form of a reinforced frame that installs along any existing door frame 3. The mounting frame 11 not only reinforces the door frame 3 it is installed on, but also serves as the mounting platform for the components the constitutes the frame door locking assembly 1. In the preferred embodiment of the present invention, the mounting frame 11 is made out of steel, but may be made out of any other suitable material. The at least one latch assembly 13 is distributed about the mounting frame 11. The at least one latch assembly 13 is hingedly connected to the at least one track assembly 12, as shown in FIGS. 5-6. The at least one actuator 14 is connected adjacent to the mounting frame 11, as shown in FIG. 4. The at least one actuator 14 is operatively engaged to the at least one track assembly 12, where the at least one actuator 14 is configured to move the at least one track assembly 12 between a locked configuration 4 and an unlocked configuration 5. The processing unit 15 is electronically connected to the at least one actuator 14. In the preferred embodiment of the present invention, the track assembly bridges the at least one latch assembly 13 to the at least one actuator 14, such that the track assembly actuates the at least one latch assembly 13 along the door frame 3. In the preferred embodiment of the present invention, the at least one actuator 14 may take the form of a solenoid linear actuator but may take the form of any other suitable actuator. The at least one latch assembly 13 serves as the locking agent. In the unlocked configuration 5, the at least one latch assembly 13 is retracted within the mounting frame 11. In the locked configuration 4, the at least one latch assembly 13 deploys out of the mounting frame 11, such that the at least one latch assembly 13 secures along the door 2, securing the door 2 to the mounting frame 11. In the preferred embodiment of the present invention, the at least one track assembly 12 is made out of steel, but may be made out of any other suitable material. In the preferred embodiment of the present invention, the at least one latch assembly 13 is made out of steel, but may be made out any other suitable material. In the preferred embodiment of the present invention, the mounting frame 11 is installed along the interior side of the door frame 3, such that the at least one track assembly 12 and the at least one latch assembly 13 is oriented along the interior side of the door 2. In this orientation, the frame door locking assembly 1 is designed to prevent intruders from kicking or breaking down the door 2 from the outside.

In the preferred embodiment of the present invention, each of the at least one track assembly 12 comprises an action bar 121 and a cam tab 122, as shown in FIGS. 5-6. Each of the at least one latch assembly 13 comprises a mounting bracket 131 and a locking latch 132, as shown in FIGS. 5-6. The action bar 121 is slidably connected to the mounting frame 11. The cam tab 122 is connected adjacent to the action bar 121. The mounting bracket 131 is distributed about the mounting frame 11. The locking latch 132 is pivotally connected to the mounting bracket 131. The cam tab 122 is pivotally connected to the locking latch 132. In the preferred embodiment of the present invention, the action bar 121 serves a linkage bar that bridges the locking latches 132 together, such that the locking latches 132 move in unison along the action bar 121. In the preferred embodiment of the present invention, the mounting bracket 131 facilitates the mounting of the locking latch 132 to the door frame 3. In the preferred embodiment of the present invention, four mounting brackets 131 may be and distributed on upper and lower sections along the mounting frame 11, such that two mounting brackets 131 are positioned on the right and left sides of the door 2 along the upper section, and two mounting brackets 131 are positioned on the right and left sides of the door 2 along the lower portion. In various embodiments, the mounting brackets 131 may be distributed in any strategic orientation, such that the locking latch 132 is installed evenly along the mounting frame 11 and distributed evenly along the door 2. In the preferred embodiment of the present invention, the locking latch 132 may take the form of reinforced steel locking latches 132 but may be made out of any other suitable material.

In the preferred embodiment of the present invention, the locking latch 132 comprises a locking arm 133, a cam body 134, and a locking cam groove 135, as shown in FIGS. 5-6. The locking arm 133 is connected adjacent to the cam body 134. The locking arm 133 serves as the door engagement portion of the locking latch 132, as shown in FIG. 1. The cam body 134 serves as the mounting frame 11 portion of the locking latch 132. The locking cam groove 135 is positioned adjacent to the cam body 134, opposite to the locking arm 133. The cam tab 122 of the action bar 121 is pivotally connected to the locking cam groove 135. In the preferred embodiment of the present invention, the pivotal connection between the cam tab 122 and the action is outfitted with roller bearings to facilitate smooth operation.

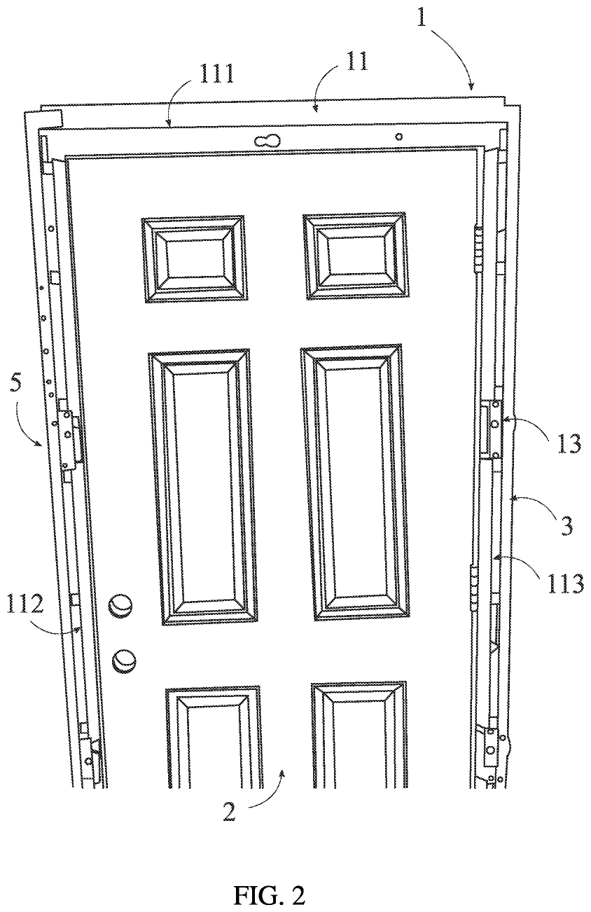

In the preferred embodiment of the present invention, the mounting frame 11 comprises an upper locking bar 111, a first track panel 112, and a second track panel 113, as shown in FIGS. 2-3. The first track panel 112 and the second track panel 113 are connected terminally opposite to each other along the upper locking bar 111. In the preferred embodiment of the present invention, the upper locking bar 111 is connected along the upper portion of the door frame 3. The first track panel 112 and the second track panel 113 are connected along the left and right side portions of the door frame 3. The at least one track assembly 12 traverses along the first track panel 112. The at least one track assembly 12 traverses along the second track panel 113.

In the preferred embodiment of the present invention, the frame door locking assembly 1 comprises a releasing element 16, as shown in FIGS. 3 and 7. The releasing element 16 is connected to the mounting frame 11. The releasing element 16 is operatively engaged to the at least one track assembly 12 where the releasing element 16 is configured to move the at least one track assembly 12 to an unlocked configuration 5. In the preferred embodiment of the present invention, the releasing element 16 is connected to the upper locking bar 111. In the preferred embodiment of the present invention, the releasing element 16 is at least one gas piston. Each of the at least one gas piston is installed along the upper locking bar 111 and is connected to the action bar 121 to the left and right sides of the frame door locking assembly 1. The at least one gas piston exerts upwards force along the action bars 121, keeping the at least one latch assembly 13 in an unlocked configuration 5 until the actuator retracts downwards to put the at least one latch assembly 13 to a locked configuration 4. The releasing element 16 serves as a failsafe mechanism, in the event the actuators fail, preventing the door 2 from being seized by the frame door locking mechanism 1. In various embodiments, the releasing element 16 may take the form of any other suitable releasing element 16, such as, but not limited to springs, quick release knobs, or any other suitable releasing element 16.

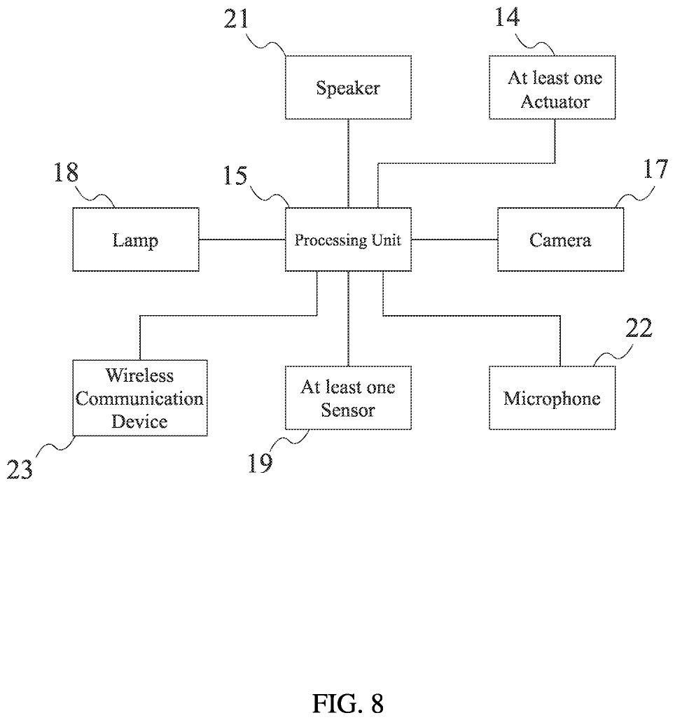

In the preferred embodiment of the present invention, the frame door locking assembly 1 further comprises a camera 17, a lamp 18, at least one sensor 19, a speaker 21, a microphone 22, and a wireless communication device 23, as shown in FIG. 8. The camera 17 is electronically connected to the processing unit 15. The lamp 18 is electronically connected to the processing unit 15. The motion sensor is electronically connected to the processing unit 15. The speaker 21 and the microphone 22 are electronically connected to the processing unit 15. The wireless communication device 23 is electronically connected to the processing unit 15. In the preferred embodiment of the present invention, the camera 17 serves as an optical sensory implement that may trigger the actuator to activate the frame door locking assembly 1 to a locked configuration 4. The camera 17 may also serve as a surveillance camera 17, such that optical data input is transmitted from the wireless communication device 23 to any suitable surveillance device such as a portable mobile device, television, or any other suitable surveillance device. The lamp 18 serves as an illumination source to illuminate the area directed to the camera 17 or motion sensor. The door 2 locking assembly may further implement motion or impact sensors along the mounting frame 11 such that the door 2 locking assembly will automatically actuate to a locked configuration 4 in the event of an intruder inflicting a specified degree of force to the door 2.

In the preferred embodiment of the present invention, the microphone 22 serves as an audio data input sensor, such that the microphone 22 can record audio data that can then be transmitted through the wireless communication device 23 to a portable communication device, or any other suitable device. The microphone 22 may also serve as an audio sensor, such that the frame door locking assembly 1 is actuated to a locked configuration 4 if the audio sensor picks up a specified audio degree decibel reading. In this instance, the specified audio degree decibel reading may be calibrated to the decibel reading comparable to a gun shot, scream, door banging noise, or any other suitable decibel reading. The speaker 21 may serve as an external means to deter intruders. In one instance, the speaker 21 can emit a siren or any other alarming noise. In another instance, the speaker 21 may broadcast a voice recording or live audio from the user.

Although the invention has been explained in relation to its preferred embodiment, it is to be understood that many other possible modifications and variations can be made without departing from the spirit and scope of the invention as hereinafter claimed.

What is claimed is:

1. A frame door locking assembly comprising:
a mounting frame;
at least one track assembly;
at least one latch assembly;
at least one actuator;
a processing unit;
the at least one track assembly traversing along the mounting frame;
the at least one latch assembly being distributed about the mounting frame;
the at least one latch assembly being hingedly connected to the at least one track assembly;
the at least one actuator being connected adjacent to the mounting frame;
the at least one actuator being operatively engaged to the at least one track assembly, wherein the at least one actuator is configured to move the at least one track assembly in a locked configuration and an unlocked configuration; and
the processing unit being electronically connected to the at least one actuator.

2. The frame door locking assembly as claimed in claim 1 comprising:
each of the at least one track assembly comprising an action bar, and a cam tab;
each of the at least one latch assembly comprising a mounting bracket and a locking latch;
the action bar being slidably connected to the mounting frame;
the cam tab being connected adjacent to the action bar;
the mounting bracket being distributed about the mounting frame;
the locking latch being pivotally connected to the mounting bracket; and
the cam tab being pivotally connected to the locking latch.

3. The frame door locking assembly as claimed in claim 2 comprising:
the locking latch comprising a locking arm, a cam body, and a locking cam groove;
the locking arm being connected adjacent to the cam body;
the locking cam groove being positioned adjacent to the cam body, opposite to the locking arm; and
the cam tab being pivotally connected to the locking cam groove.

4. The frame door locking assembly as claimed in claim 1 comprising:
the mounting frame comprising an upper locking bar, a first track panel, and a second track panel; and
the first track panel and the second track panel being connected terminally opposite to each other along the upper locking bar.

5. The frame door locking assembly as claimed in claim 4 comprising:
the at least one track assembly traversing along the first track panel;
the at least one track assembly traversing along the second track panel;
the at least one latch assembly being distributed about the first track panel; and
the at least one latch assembly being distributed about the second track panel.

6. The frame door locking assembly as claimed in claim 1 comprising:
a releasing element;
the releasing element being connected to the mounting frame; and
the releasing element being operatively engaged to the at least one track assembly, wherein the releasing element is configured to move the at least one track assembly to an unlocked configuration.

7. The frame door locking assembly as claimed in claim 1 comprising:
a releasing element;
the releasing element being connected to the upper locking bar; and
the releasing element being operatively engaged to the at least one track assembly, wherein the releasing element is configured to move the at least one track assembly to an unlocked configuration.

8. The frame door locking assembly as claimed in claim 7, wherein the releasing element is at least one gas piston.

9. The frame door locking assembly as claimed in claim 1 comprising:
a camera; and
the camera being electronically connected to the processing unit.

10. The frame door locking assembly as claimed in claim 1 comprising:
a lamp; and
the lamp being electronically connected to the processing unit.

11. The frame door locking assembly as claimed in claim 1 comprising:
at least one sensor; and
the motion sensor being electronically connected to the processing unit.

12. The frame door locking assembly as claimed in claim 11, wherein the at least one sensor comprises a motion sensor.

13. The frame door locking assembly as claimed in claim 11, wherein the at least one sensor comprises an impact sensor.

14. The frame door locking assembly as claimed in claim 1 comprising:
a speaker;
a microphone; and
the speaker and the microphone being electronically connected to the processing unit.

15. The frame door locking assembly as claimed in claim 1 comprising:
a wireless communication device; and
the wireless communication device being electronically connected to the processing unit.
